(19) United States
(12) Patent Application Publication
(10) Pub. No.: US 2020/0127370 A1
(43) Pub. Date: Apr. 23, 2020

(54) Antenna Coupled MIM with Full Bridge MIM Rectifier

(71) Applicant: ORYX VISION LTD., Kiryat Ono (IL)

(72) Inventors: David BEN-BASSAT, Ganey Tikva (IL); Tal HAVDALA, Rishon le Zion (IL)

(21) Appl. No.: 16/483,543

(22) PCT Filed: Feb. 4, 2018
(86) PCT No.: PCT/IL2018/050118

§ 371 Date: Aug. 5, 2019

Related U.S. Application Data
(60) Provisional application No. 62/454,814, filed on Feb. 5, 2017.

(51) Int. Cl. H01Q 1/24; H01Q 1/38; H04B 10/69

(52) U.S. Cl. CPC H01Q 1/248; H04B 10/69; H01Q 1/38

(57) ABSTRACT

An apparatus configured to receive electromagnetic signals is provided, wherein the apparatus comprising: an antenna configured to receive the electromagnetic signals which is coupled with a full-wave MIM rectifier; and a full-wave MIM structure, comprising a plurality of MIM elements, for improving utilization of energy available at the antenna feed points.

### TECHNICAL FIELD

The present disclosure generally relates to the field of electro-magnetic sensors. More particularly, the present disclosure relates to antenna coupled metal-insulator-metal (ACMIM) detectors.

### BACKGROUND

Antenna coupled metal-insulator-metal (ACMIM) detectors are electro-magnetic sensors designed to operate at frequencies where semiconductors usually fail to do, due to time constants associated with such devices. A typical ACMIM is a monolithic component, which comprises two fundamental elements:
An antenna: the antenna serves as a mean to transduce electro-magnetic energy to electrical energy. Typically, the antenna size is about ½ the wavelength of the detected wave. As ACMIMs are usually designed to detect frequencies within the range of 1-300 THz, the antenna size is typically 100-0.5 μm. Such small sized antennas are usually fabricated in a thin film process, utilizing lithography to pattern the antenna onto a carrier substrate.
A Metal-Insulator-Metal rectifier. A metal-insulator-metal structure is typically a thin-film structure, having two conductive materials separated from each other by a thin insulating layer. When voltage is applied onto the conductive layers, current is generated in conformity with the effect named tunneling. Tunneling is a non-linear, very high-speed phenomenon, thus MIM structures serve as very high-speed rectifiers/frequency mixers.

Usually, MIM structures exhibit non-linear current-versus-voltage [I(V)] properties. A typical current-versus-voltage graph for a MIM structure is presented in FIG. 1.

When interrogating a MIM structure with AC signals, the non-linearity properties yield two fundamental functions:
a) Rectification: a MIM structure can be perceived as a small-signal diode. This is especially relevant if the MIM structure is DC biased to an operating point.
b) Harmonic content/frequency mixer: by the same perception of a MIM structure as a small-signal diode, it will yield the harmonics of the fundamental frequency. It may be shown that an ACMIM can be considered as a square-law detector. As such, it converts electro-magnetic power to currents. The responsivity of an ACMIM in given in the following Equation 1:

$$R = {γ}_{ant} {γ}_{z} \frac{\frac{{\partial }^{2} I}{\partial {V}^{2}}}{\frac{\partial I}{\partial V}} [ \frac{A}{W} ] \qquad ( Eq . 1 )$$

where:
R is responsivity expressed in [Ampere/Watt];
I(V) is the characteristic of the MIM;
γₐₙₜ is the antenna radiation efficiency; and
γ_{Z} is the impedance matching efficiency between antenna and MIM.

ACMIM structures can be used as either rectifiers or as frequency mixers. When subjected to electro-magnetic energy, the ACMIM functions as a sensor. Another possible application is a frequency mixer: when subjected to two coherent sources simultaneously, the antenna would pick up both signals, inducing two AC signals across the MIM load. In this case, the MIM serves as a frequency mixer, yielding a beat frequency, that is the difference frequency between the two harmonic interrogating signals.

Several successful ACMIM structures have been reported in the art. As of the 1970s, such structures were designed, made and tested at various levels of success. Yet, in all these cases, a single MIM load was placed at the feed point of an antenna. This concept is illustrated in FIG. 2.

As shown in FIG. 2, a differential antenna topology has typically been implemented (in this schematic drawing, a bowtie antenna is illustrated). The non-linear MIM load was placed at the feed point of the antenna, and the picked-up electromagnetic signals induced AC currents through the MIM load. The non-linear nature of the MIM load rectified and mixed the AC signals, resulting in obtaining a DC signal. Equation No. 1 is a second order approximation of the functionality implemented by the topology illustrated in this FIG. 2.

An analogy to this concept is a diode rectifier, also known as a half-wave rectifier. FIG. 3 is an illustration of a half wave rectifier functionality. The resistor R in this FIG. 3, represents the antenna impedance, i.e. radiation resistance.

A typical responsivity curve of a MIM structure is presented in FIG. 4. The curve shown is a graphical illustration of a MIM junction responsivity, as derived from Equation 1. The responsivity in this graph is presented in Amp/Watt units, and the DC voltage bias is presented in Volts.

As one may observe from this FIG., maximal responsivity is achieved when the unit is biased to certain DC operating points. In this specific graph, a peak responsivity is achieved at a bias voltage of ˜150 mV (positive responsivity) and −150 mV (negative responsivity).

In some cases, in order to maximize the responsivity, DC biasing is applied to the ACMIM structure. An illustration of an ACMIM with a DC biasing and readout circuitry is presented in FIG. 5.

As may be seen in FIG. 5, DC voltage source is used to DC bias the MIM. A Trans impedance amplifier (implemented as an operational amplifier with a negative resistive feedback) amplifies the current flowing through the MIM structure. As the MIM rectifies AC current, the amplified current results from a sum of the DC current together with the detected signal.

RF chokes (illustrated in this FIG. in the form of inductors) are used to isolate the antenna from the DC elements. Other possible topologies for DC biasing a readout of ACMIM structures, are also known in the art.

However, all prior art solutions were made using a single MIM load at the antenna feed point for an antenna-coupled MIM sensors and detectors. In some cases, the load was DC biased to gain a better rectification point (i.e. a better responsivity of the detector). Nonetheless, as shown in FIG. 3, this implementation is effectively equivalent to using a half wave rectifier. In other words, 50% of the energy available at the antenna feed points, is not utilized for rectification. The present invention seeks to provide a solution that improves the utilization of energy available at the antenna feed points.

### SUMMARY

The disclosure may be summarized by referring to the appended claims.

It is an object of the present disclosure to provide a novel receiver that improves the utilization of energy available at the antenna feed points.

It is another object of the disclosure to provide a full-wave rectifying ACMIM having an effective impedance that matches that of a half-wave rectifying ACMIM.

It is still another object to provide a full-wave rectifying ACMIM apparatus which has a better performance than that of prior art ACMIM devices.

Other objects of the present disclosure will become apparent from the following description.

According to a first embodiment of the present disclosure, there is provided an apparatus configured to receive electromagnetic signals, which comprises:

an antenna coupled with a MIM structure (“ACMIM”) configured to receive the electromagnetic signals, and wherein the antenna is coupled with a full-wave MIM structure; and

a full-wave MIM structure, comprising a plurality of MIM elements, for providing rectification for the received signals being converted to electrical signals.

In accordance with another embodiment, the full-wave MIM structure comprises four MIM elements. Preferably, a pair of the four MIM elements are connected to each other in series, and in parallel to the other pair MIM elements of the four MIM elements, thereby, this structure is characterized by having a full-bridge signal rectifier topology.

According to still another embodiment, the full-wave MIM structure is configured to operate as a frequency mixer.

By yet another embodiment, an equivalent load of the plurality of MIM elements is configured to impedance match a load of the antenna, in order to increase transfer of power from the antenna to the load of the plurality of MIM elements (i.e. the rectifier).

According to still another embodiment, the full-wave MIM structure has a nonlinear electrical response based on a tunnel effect.

In accordance with another embodiment, the apparatus further comprises a coupling means configured to enable joining a concentrating device of the electromagnetic signals being received, to the antenna.

### BRIEF DESCRIPTION OF THE DRAWINGS

The accompanying drawings, which are incorporated herein and constitute a part of this specification, illustrate several embodiments of the disclosure and, together with the description, serve to explain the principles of the embodiments disclosed herein.

FIG. 1 is a schematic representation of a typical current-versus-voltage relationship for a prior art MIM structure;

FIG. 2 is a schematic illustration of a prior art ACMIM structure having a single MIM load placed at the feed point of the antenna;

FIG. 3 is a prior art illustration of an equivalent schematic representation in a form of an electric circuit of a half wave rectifier functionality;

FIG. 4 illustrates a typical responsivity curve of a prior art MIM structure;

FIG. 5 presents a prior art ACMIM configuration with a DC biasing and readout circuitry;

FIG. 6 illustrates a device construed in accordance with an embodiment of the present invention which comprises an antenna coupled with a full-bridge rectifying MIM structure;

FIG. 7A demonstrates a configuration of a device construed in accordance with an embodiment of the present invention;

FIG. 7B demonstrates a top view of the device of FIG. 7A;

FIG. 7C demonstrates a side view of the device of FIG. 7A; and

FIG. 8 illustrates of one possible option for DC biasing a full-bridge topology as proposed by an embodiment of the present invention.

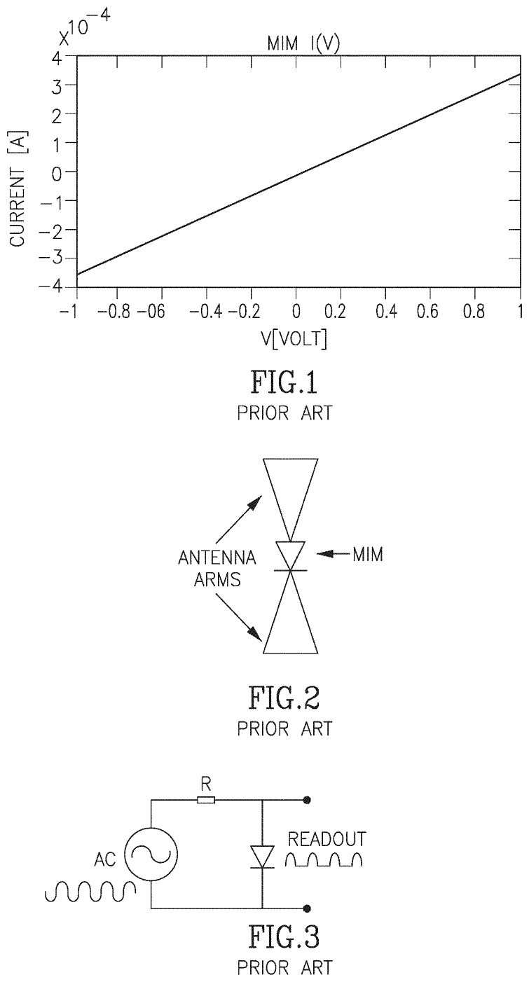

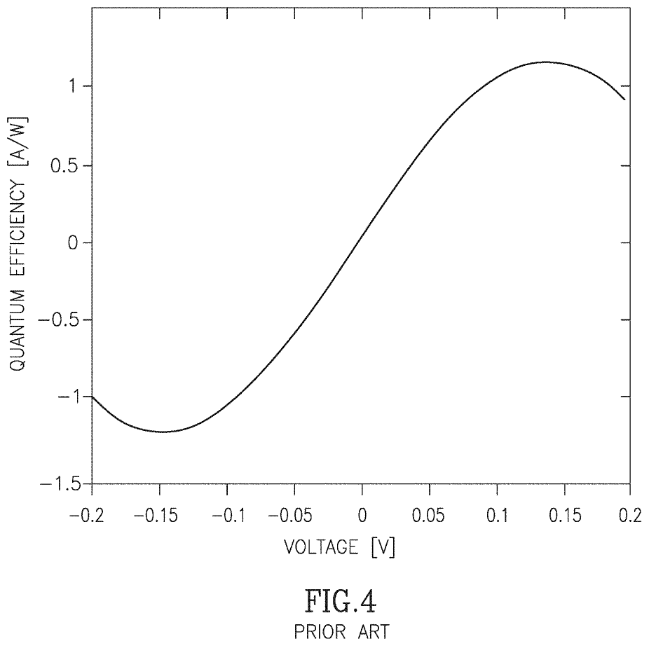

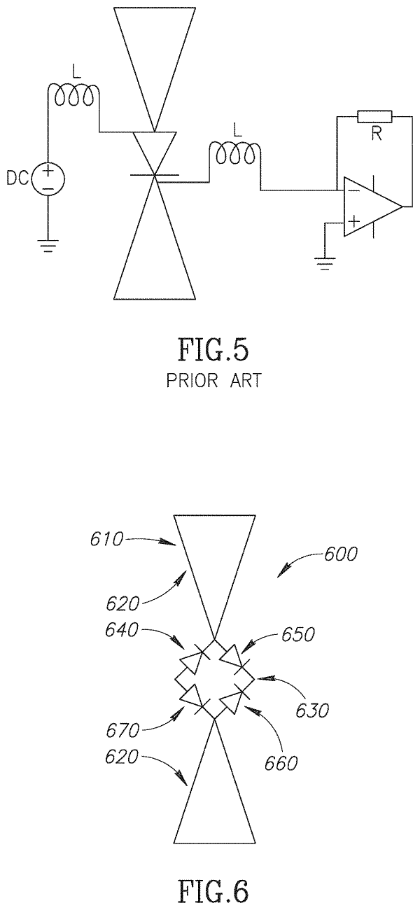

### DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods that are known in the art per se. In addition, the described embodiments comprise different steps, not all of which are required in all embodiments of the invention. The scope of the invention can be summarized by referring to the appended claims.

The antenna referred to herein is a device used to convert the arriving electromagnetic signal into an electrical signal.

The antenna element may be in a form of a single antenna, or in the alternative, a number of antennas connected together to form an antenna array. Also, a differential antenna, as well as a single-ended antenna, may be applicable. The antenna's dimensions should preferably be of the same order of magnitude as the wavelength of the received signals (e.g. optical signals have a typical wavelength in the range of 850 to 1550 nm, or long wave IR signals in the range of 8-14 um). Such dimensions dictate specific production processes and materials. The antenna may preferably be patterned in e-beam or Deep Ultra Violet (DUV) photo lithography, and manufactured by applying Physical Vapor Deposition (PVD) technology. Yet, other patterning and manufacturing technologies could also be implemented, all without departing from the scope of the present disclosure. In addition, the right material for the antenna should be selected, taking into account its conductivity and refractive index when designing the antenna. Selecting a wrong material might result in an antenna having a poor efficiency. For operating the antenna at such high frequencies, materials such as gold, aluminum and silver may be considered as possible options.

The arriving electro-magnetic signal is received at the antenna where its electromagnetic energy is picked and converted into an electrical form. At the antenna port, the electrical power is harvested with an impedance-matched load. This electrical power is received at operating frequencies of the order of magnitude of THz (e.g. 1-300 THz), depending on the wavelength at which the signal was received.

As a common practice in radio engineering, antenna arrays can also be implemented according to some embodiments of the disclosure. Typical antenna arrays are arranged in pre-defined offsets, and are inter-connected by impedance matched wave guides that can enhance the antenna performance.

By loading the antenna port with a matched non-linear load, rectification or frequency mixing will occur. The result will be a DC electrical signal, which is proportional to the power at which the signal was received by the antenna. When implementing the mixing topology, the resulting electrical signal shall be a beat frequency equal to the difference frequency between the two interrogating signals. A rectifying element that operates well within the band of about 1-300 THz may be based on quantum physics phenomena known as tunneling. Tunneling effect is a non-linear phenomenon that occurs within femto-seconds. As mentioned before, this is the basis for a high-speed rectifier/frequency mixer being referred to herein as MIM.

Rectification quality (defined as the ratio between the output power of the rectified DC signal and the input power of the optical signal) is related to as the non-linearity of the MIM. MIM elements exhibit different non-linearity in different DC bias points. Therefore, a DC circuit is used to bias the MIM element to an optimal rectification point.

As described above, the prior art solutions relied on utilizing a single MIM load at the antenna feed point, when using an antenna-coupled MIM sensors and detectors. As discussed for example with respect to FIG. 3, implementing such a configuration is effectively equivalent to the use of a half wave rectifier. In other words, 50% of the energy available at the antenna feed points, would not be utilized for rectification when implementing the prior art solution.

The solution provided by the present invention is directed to the use of an antenna coupled with a full-bridge rectifying MIM structure. A schematic presentation of an embodiment of the proposed solution is illustrated in FIG. 6, which depicts a device 600 that comprises an antenna 610 having two antenna arms 620 and a full wave (i.e. bridge) rectifier 630 positioned there-between.

As may be seen in this FIG., the antenna feed points are loaded by the full bridge, so that the read-out signal is differentially generated between the full bridge arms.

It was previously mentioned that an ACMIM may be considered as a square-law detector. Since the proposed solution relies on using a full-wave rectifier instead of the half-wave rectifier used in the art, therefore, the responsivity of such an ACMIM is given in the following Equation 2, by which:

$$R = 2 {γ}_{ant} {γ}_{z} \frac{\frac{{\partial }^{2} I}{\partial {V}^{2}}}{\frac{\partial I}{\partial V}} [ \frac{A}{W} ] \qquad Eq . 2$$

where:
R is responsivity expressed in [Ampere/Watt];
I(V) is the characteristic of the MIM;
γₐₙₜ is the antenna radiation efficiency; and
γ_{Z} is the impedance matching efficiency between antenna and MIM.

Thus, it is clear that the responsivity of a device construed in accordance with the present invention, is twice as much when compared with the responsivity that can be achieved by using prior art solutions that follow Eq. 1 above.

One key issue that needs to be taken into account when considering ACMIM structures is, the impedance matching between the antenna and the load. Let us assume that the antenna impedance is Zₐₙₜ and that the MIM load impedance is Z_{MIM}, the reflection coefficient of a typical prior art ACMIM structure is given by the following Equation 3:

$$ϵ = \frac{{Z}_{MIM} - {Z}_{ant}}{{Z}_{MIM} + {Z}_{ant}} \qquad Eq . 3$$

where:
Z_{MIM} the MIM load impedance;
Zₐₙₜis the antenna impedance; and
ϵ is the reflection coefficient.

In the embodiment of the present invention illustrated in FIG. 6, the full wave rectifier 630 comprises 4 MIM elements, or in other words, the antenna is loaded by four MIM elements 640, 650, 660 and 670. As may be further seen in this FIG., according to this embodiment, two if the MIM elements (640 and 650) are connected to each other in series, and then connected in parallel to the two other MIM elements, 660 and 670, which are also connected to each other in series. The equivalent load of this configuration is the same as for a single MIM load (as demonstrated in the following Equation 4), hence the impedance matching for the case where a full-wave rectifying ACMIM would be the same as in the case where a half-wave rectifying ACMIM is used.

Z_{eq}=(Z_{MIM}+Z_{MIM})∥(Z_{MIM}+Z_{MIM})=Z_{MIM} Eq. 4

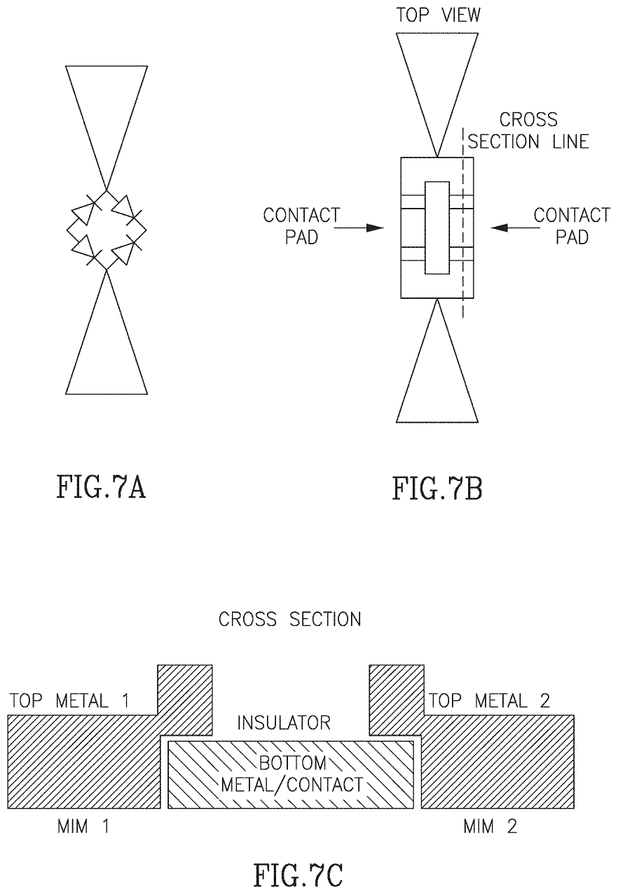

As would be appreciated by those skilled in the art, there are various ways to implement the proposed solution. FIGS. 7A to 7C illustrate one such example of implementing the solution provided by the present invention. FIG. 7A demonstrates the configuration of the device, whereas FIG. 7B demonstrates a top view of such a device, showing the two contact pads that are used in this example, while FIG. 7C demonstrates a side view thereof. The side view is a cross-section of the MIMIM (i.e. a metal-insulator-metal structure followed by another metal-insulator-metal structure, where there is a metal layer that is shared by both structures) area, where the full-bridge rectification is implemented.

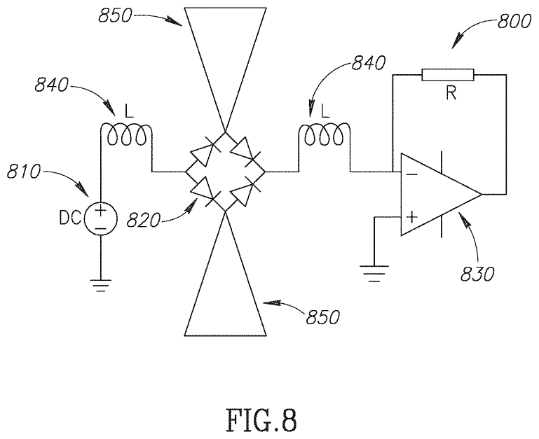

As described hereinabove, DC biasing of tunnel junctions is sometimes applied in order to improve the overall responsivity. FIG. 8 is an illustration of one possible way to DC bias the full-bridge topology proposed by the solution of the present invention.

Apparatus 800 illustrated in FIG. 8, comprises a DC voltage source 810 which is configured to DC bias the MIM bridge structure 820. Given the polarity of DC source 810, the bridge can be modeled as a small-signal diode bridge. A Trans impedance amplifier 830 (implemented as an operational amplifier with negative resistive feedback) amplifies the current rectified by the MIM bridge structure. As the MIM bridge structure rectifies AC currents, the current amplified is a sum of the DC current together with the detected signal. RF chokes 840 (illustrated in FIG. 8 as inductors) may be used to isolate antenna 850 from the DC elements.

As will be appreciated by those skilled in the art, there are other possible topologies for using a DC biasing for a readout of ACMIM structures, all without departing from the scope of the present invention, hence they should be understood to be encompassed by the present invention.

Other embodiments of the invention will be apparent to those skilled in the art from consideration of the specification and practice of the invention disclosed herein, for example cases where signals are conveyed to the antenna via a suitable media (such as for example a waveguide/ an optical fiber) in the addition or in the alternative of being conveyed in free space. It is intended that the specification and examples be considered as exemplary only, with a true scope and spirit of the invention being indicated by the following claims.

What is claimed is:

1. An apparatus configured to receive electromagnetic signals, comprising:
an antenna configured to receive said electromagnetic signals, wherein said antenna is coupled with a full-wave MIM rectifier; and
a full-wave MIM structure, comprising a plurality of MIM elements.

2. The apparatus of claim 1, wherein said full-wave MIM structure comprises four MIM elements.

3. The apparatus of claim 2, wherein two of said four MIM elements are connected to each other in series, and in parallel to the two other MIM elements of said four MIM elements.

4. The apparatus of claim 1, wherein an equivalent load of said plurality of MIM elements is configured to impedance match a load of said antenna.

5. The apparatus of claim 1, wherein the full-wave MIM structure has a nonlinear electrical response based on a tunnel effect.

6. The apparatus of claim 1, wherein the full-wave MIM structure is configured to operate as a frequency mixer.
